(19) United States
(12) Patent Application Publication
(10) Pub. No.: US 2002/0129613 A1
(43) Pub. Date: Sep. 19, 2002

(54) Cryogenic refrigeration unit suited for delivery vehicles

(75) Inventors: Herman H. Viegas, Bloomington, MN (US); Jayaram Seshadri, Minneapolis, MN (US); Hans-Olof Nilsson, Agnesbert (SE)

Correspondence Address: MICHAEL BEST & FRIEDRICH LLP, 3773 CORPORATE PARKWAY, SUITE 360, CENTER VALLEY, PA, 18034-8217, US

(73) Assignee: Thermo King Corporation, Minneapolis, MN (US)

(21) Appl. No.: 10/066,971

(22) Filed: Feb. 4, 2002

Related U.S. Application Data
(60) Provisional application No. 60/238,929, filed on Oct. 10, 2000.

(51) Int. Cl. B60H 1/32; F25B 27/00

(52) U.S. Cl. 62/239; 62/323.2

(57) ABSTRACT

An apparatus to refrigerate the cargo space of delivery vehicles. It provides an environmentally friendly alternative to conventional mechanical a/c and refrigeration units. Cooling is provided by controlled evaporation of a liquefied gas such as CO₂ or nitrogen. Defrost and heating requirements, if needed, are provided by hot engine coolant or by electric heaters powered from the vehicle electrical system. Airflow for the evaporator and for circulation in the temperature controlled space is provided by a blower which is mechanically or electrically driven from vehicle power. This invention can also be applied to multi-temperature control applications. The apparatus is compact and is particularly suited for small inner city delivery vehicles.

FIG. 1: The sketch shows an inner city delivery truck for which this invention is most suitable. Refrigerated goods are placed in roller cages that are designed to maximize cargo hauled by use of roller cages that extend to within 2 inches of the ceiling. The evaporator section of this invention is mounted at or near the front wall of the truck and is separated from the cargo by a vertical bulkhead. The conditioned air is delivered at the bottom of the truck to avoid top freeze of perishable cargo that is in close proximity to the ceiling.

FIG. 2: This shows the piping schematic and is similar to the invention described in U.S. Application Serial No. 60/238,929 (the '929 application) incorporated herein by reference. FIG. 2 shows the engine coolant coil located ahead of the CO₂ coil in the direction of airflow. This prevents the coldest air from coming in contact with the engine coolant—in the cooling mode the air leaving the CO₂ coil can be as low as −50° F. for frozen load applications and this may cause the engine coolant to start freezing. Arrangements must be made to circulate air between the two coils in defrost mode. One means to accomplish this is to place a damper at the outlet of the evaporator section and run the fans. The damper would be closed during defrost. Another method is to place the engine coolant coil on the discharge side of the CO₂ coil and use a cut-out switch if the engine coolant temperature drops below a predetermined value. In this arrangement there is no need for the damper arrangement as the heat will rise to melt any frost on the CO₂ coil. If electric heat is used for defrost and heating freezing of the engine coolant is not a concern and the heaters can be fastened to the discharge side of the CO₂ coil. An electric stand-by mode can be provided to power the system for cooling, heating and defrost when the vehicle is parked with the engine off. A plug-in electrical cable can provide the power needed for the controls, the fans and for heating and defrost. The figure shows the electric heaters attached on the discharge side of the CO₂ coil.

Operation: Detailed description is in the '929 application except for the following: The evaporator section is designed for vertical installation to maximize cargo space. Air is discharged at the bottom but may be a conventional top discharge if needed for specific applications. Conventional methods can be used to provide defrost and heating. If engine coolant is used for a heat source, it is preferable to thermally isolate the CO₂ coil from the engine coolant coil to avoid freezing the coolant. The evaporator blower may be located on the inlet side of the coils rather than as shown in the figures.

Unique Features:

1. Absence of a conventional condensing section on the exterior of the vehicle makes this an ideal refrigeration unit for small inner city delivery vehicles. Many of the truck cabs are now almost full height (same as the truck body) and there is limited space for the condensing section.

2. Cold plates can be used and still maximize cargo cube. However, this invention has 30-40% less weight than comparable “cold plate” systems.

3. Other features are described in the '929 application.]

### CROSS-REFERENCE TO RELATED APPLICATIONS

This application claims priority under 35 U.S.C. § 119 to U.S. Provisional Patent Application No. 60/238,929 titled TEMPERATURE CONTROL SYSTEM, and filed on Oct. 10, 2000.

### BACKGROUND AND SUMMARY OF THE INVENTION

The present invention relates to temperature control systems, and particularly to cryogenic temperature control systems. More particularly, the present invention relates to cryogenic temperature control systems which include a heating coil and blower.

Conventional temperature control systems typically include mechanical, non-mechanical, and hybrid systems. These systems are applicable to both stationary and mobile applications. In motor vehicles, these systems are particularly applicable to, for example, trucks having air-conditioned trailers or containers, buses having air-conditioned passenger cabins, etc. Mechanical systems compress and condense a refrigerant and subsequently expand it before passing the refrigerant through an evaporator coil. The expansion of the refrigerant greatly reduces the temperature of the refrigerant before it passes through the evaporator coil. Then, as the cold refrigerant flows through the evaporator coil, relatively warm, unconditioned air is blown over the evaporator coil. This creates the dual effect of cooling the air flowing over the evaporator coil and vaporizing the refrigerant flowing through the evaporator coil. Typically, the vaporized refrigerant is then directed back to the compressor where the cycle is repeated. Mechanical temperature control systems such as this are typically closed systems in which the refrigerant is recycled. In this way, the relatively expensive refrigerant is not consumed and does not contaminate the atmosphere.

A typical mechanical system includes a prime mover motor. The prime mover motor is required to compress and circulate the refrigerant, and is often secondarily utilized to drive a blower which creates the airflow over the evaporator coil. This can cause typical mechanical systems to be costly, noisy, heavy, and prone to high maintenance.

Non-mechanical temperature control systems eliminate the need for a prime mover and compressor. In non-mechanical systems, a heat-absorbing fluid, often a cryogen (e.g. liquid carbon dioxide, liquid nitrogen, etc.) is expanded directly out of a storage tank into an evaporator coil. The cryogen is not passed through a compressor. Relatively warm air passing over the evaporator coil is cooled by the cold cryogen in the evaporator coil. At the same time, the cryogen is heated and vaporized by the relatively warm air passing over the evaporator coil. Once this heat transfer has occurred, the vaporized cryogen is typically exhausted to the atmosphere. However, before the vaporized cryogen is exhausted to the atmosphere, it may be utilized to drive a blower which creates the airflow over the evaporator coil. Such a system can reduce noise, cost, and maintenance problems, and can provide the cooling capacity to quickly reduce the temperature in an air-conditioned space. However, as with other air-conditioning systems, the cooling ability of the cryogen can produce frost on the evaporator coil.

Hybrid temperature control systems are also utilized to control the air temperature of a desired space. A hybrid system typically employs a mechanical temperature control system supplemented by a cryogenic system in times when rapid cooling is needed. Mechanical, non-mechanical, and hybrid systems may be used to control the temperature of a desired space in a truck trailer, truck container, bus or van passenger cabin, or any other enclosed volume or space in which temperature regulation is desired. See, for example, U.S. Pat. No. 6,062,030 to Viegas. In each case, a temperature control system that utilizes inherently available energy to drive the blower and provide heat to the evaporator would be welcomed.

According to the present invention, a cryogenic temperature control system for a motor vehicle having an engine and an air-conditioned space includes a housing having an air inlet and an air outlet. The air outlet is in fluid communication with the air-conditioned space. An evaporator coil is mounted within the housing and provides a pathway for a heat-absorbing fluid. A blower, also mounted within the housing, conveys air in the air inlet, over the evaporator coil, and out the air outlet and is driven by energy from the motor vehicle engine. A heating coil is positioned adjacent to the evaporator coil and provides a heating flow path for engine coolant flowing from the engine and back to the engine.

In preferred embodiments, the motor vehicle is a truck having a trailer or container within which it is desired to control the temperature. A cryogen, such as liquid carbon dioxide or liquid nitrogen, flows through the evaporator coil. The blower is preferably driven by electric current from the truck's alternator and blows air over the evaporator coil.

In preferred embodiments, engine coolant flowing through the engine, such as water or antifreeze, is directed through a heating circuit, which includes a heating coil integral with the evaporator coil. The heating coil heats the evaporating coil either to defrost the evaporator coil or to provide a relatively warm coil over which air from the blower passes, thereby providing warm air to the air-conditioned space.

Additional features and advantages of the invention will become apparent to those skilled in the art upon consideration of the following detailed description of preferred embodiments exemplifying the best mode of carrying out the invention as presently perceived.

### BRIEF DESCRIPTION OF THE DRAWINGS

FIG. 1 is a side view of a truck including a temperature control system embodying the present invention.

FIG. 2 is a schematic drawing of the temperature control system of FIG. 1.

FIG. 3 is a side view of a truck including a vertically-oriented construction of the temperature control system.

FIG. 4 is a schematic drawing of the temperature control system of FIG. 3.

FIG. 5 is a schematic drawing of a second embodiment of the invention applied to an air-conditioned space which is divided into multiple chambers.

### DETAILED DESCRIPTION OF THE PREFERRED EMBODIMENT

The present invention operates in conjunction with energy inherently present in a motor vehicle. For example, mechanical and electrical energy from the vehicle's engine may be utilized to fuel a heating coil and/or to drive a blower.

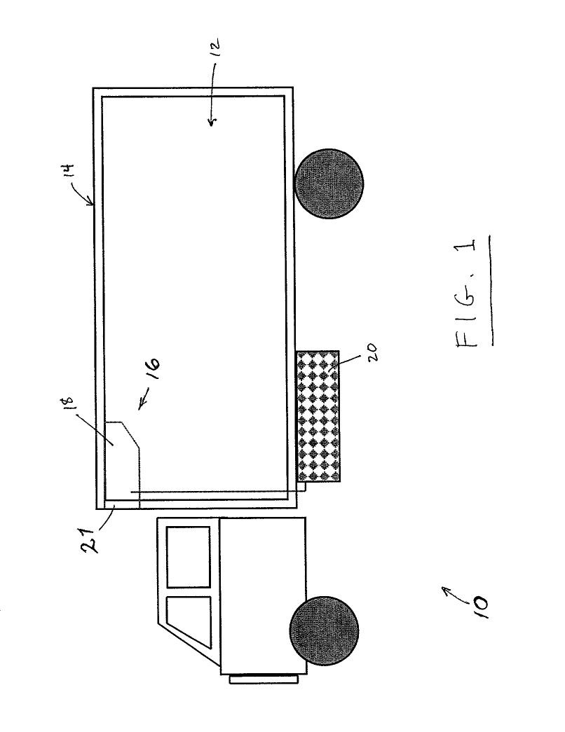

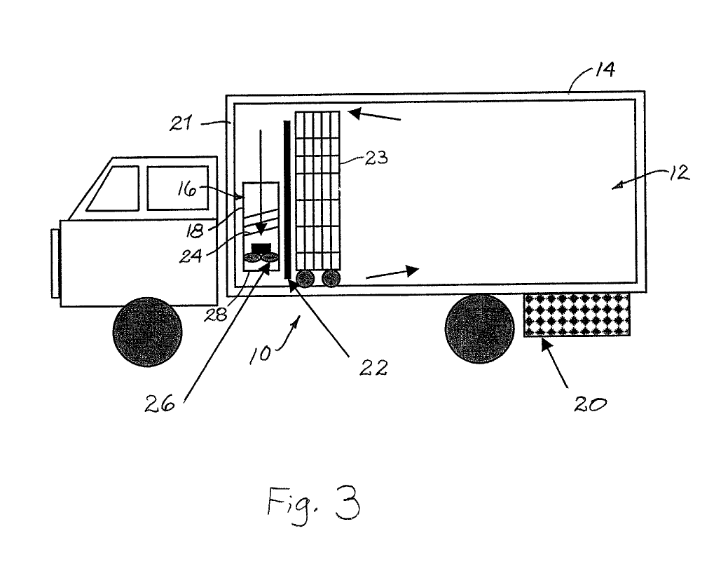

FIGS. 1 and 3 illustrate a truck 10 that includes an air-conditioned space 12 within its trailer 14. The air temperature within the air-conditioned space 12 is regulated by a temperature control system 16 that includes a temperature control housing 18 and a heat-absorbing fluid storage tank 20. The temperature control housing 18 is mounted within the air-conditioned space 12, although it may alternatively be mounted outside the air-conditioned space 12. The storage tank 20 contains a heat-absorbing fluid or cryogen, and is mounted outside of the air-condition space 12, although it may alternatively be mounted inside the air-conditioned space 12.

The temperature control housing 18 may be mounted horizontally to the ceiling of the trailer 14 (as in FIG. 1) or vertically between a front wall 21 and a bulkhead 22 within the trailer 14 (as in FIG. 3). In the vertically-oriented construction, the bulkhead 22 protects the housing 18 from roller cages 23 or other moving and shifting cargo.

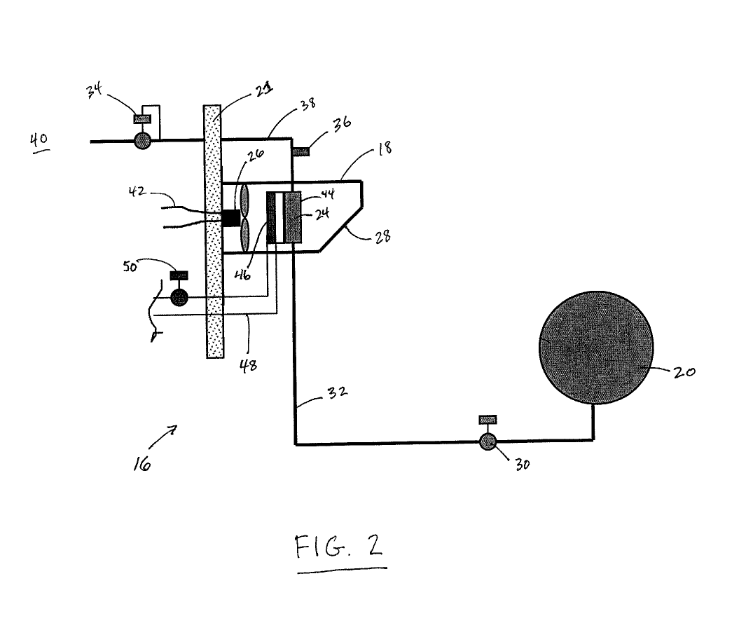

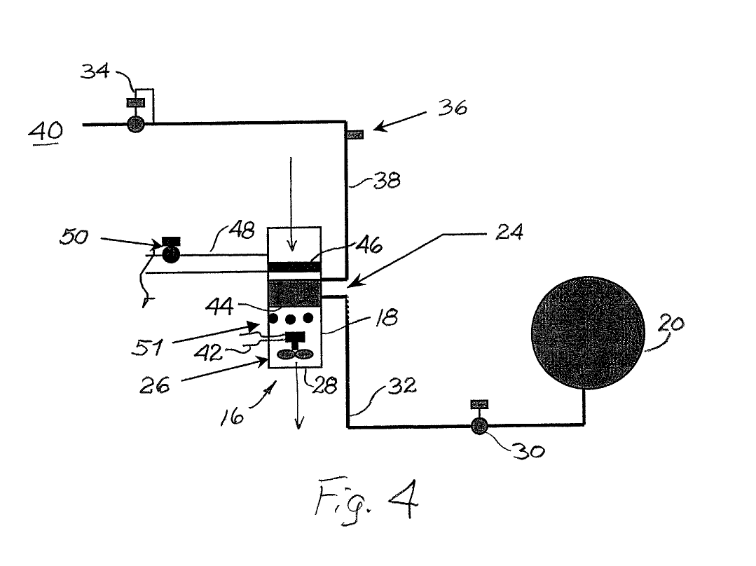

Referring now to FIGS. 2, 3, and 4, an evaporator coil 24 and blower 26 are contained within the housing 18. The blower 26 conveys air past the evaporator coil 24, and through an air outlet 28 of the housing 18. The conditioned air thus enters the air-conditioned space 12 to regulate the temperature therein. In the horizontal construction illustrated in FIGS. 1 and 2, the blower 26 blows the air over the evaporator coil 24, while in the vertical construction illustrated in FIGS. 3 and 4, the blower 26 draws air over the evaporator coil 24. It will be appreciated by those of skill in the art that the blower 26 may be positioned on the opposite side of the evaporator coil 24 in each construction. More specifically, the blower 26 may be used to draw air over the evaporator coil 24 in the horizontal construction, and may be used to blow air over the coil 24 in the vertical construction.

The horizontal construction introduces the cold air at the top of the air-conditioned space 12. The vertical construction introduces the cold air at the bottom of the air-conditioned space 12, and retrieves warmer air from the top. Introducing the cold air at the bottom of the air-conditioned space 12 reduces the likelihood of freezing perishable cargo on top of the roller cages 23. Also, because known roller cages 23 extend to within two inches of the ceiling of the air conditioned space 12, moving the temperature control system 16 from the ceiling removes overhead interference with the roller cages 23 to improve the overall space efficiency of the air conditioned space 12.

With reference to FIGS. 2 and 4, a flow control valve 30 (e.g., solenoid-controlled, manual, proportional, or any suitable mechanism for altering flow) is positioned along a first flow path 32 from the heat-absorbing fluid storage tank 20 (in this case containing liquid carbon dioxide (LCO₂)) to the evaporator coil 24. The valve 30 controls the flow of LCO₂ from the storage tank 20 to the evaporator coil 24, and through the evaporator coil 24. As the LCO₂ flows through the evaporator coil 24, the blower 26 pushes (or draws as in FIGS. 3 and 4) air over the evaporator coil 24. In this way, the relatively cold LCO₂ within the evaporator coil 24 cools the relatively warm air flowing past it before the air is expelled into the air-conditioned space 12.

A backpressure regulator 34 and temperature sensor 36 are positioned on a second flow path 38 between the evaporator coil 24 and the atmosphere 40. The backpressure regulator 34 and temperature sensor 36 are utilized to further regulate the flow of LCO₂ through the evaporator coil 24. Although FIGS. 2 and 4 illustrate a cryogenic temperature control system utilizing LCO₂ flowing along an open path to the atmosphere, it will be readily understood by one of ordinary skill in the art that other cryogens, such as LN₂ and LNG could be used in accordance with the present invention. In the case of LNG, it will be understood by one of ordinary skill in the art that the LNG can be used for engine fuel after it has passed through the evaporator.

Electric wires 42 (FIGS. 2 and 4) connect the blower 26 to the truck's engine (not shown). In this way, electric current from the engine's alternator (not shown) can be used to drive the blower 26. It will be readily apparent to one of ordinary skill in the art that the electricity used to drive the blower 26 could alternatively come from a battery, generator, or fuel cell (also not shown). In this arrangement, the blower 26 can operate even when the engine's alternator is not generating electricity (for example, when the engine is not running). Additionally, the blower 26 can be driven mechanically by the engine, for example through a direct drive engagement or through a hydraulic linkage. Alternatively, before the vaporized cryogen is exhausted to the atmosphere, it may be utilized to drive the blower 26 to create the airflow over the evaporator coil.

Because the heat-absorbing fluid flowing through the evaporator coil 24 is often very cold relative to the air to be conditioned, water vapor present in the air to be conditioned may freeze on an exterior surface 44 of the evaporator coil 24. The invention contemplates several methods for defrosting the evaporator coil 24. The first method includes the use of a heating coil 46 near the evaporator coil 24.

The heating coil 46 constitutes a segment of a third flow path 48 for the flow of engine coolant (e.g., water, antifreeze, etc.) from the engine, through the heating coil 46, and then back to the engine. A flow control valve 50 (e.g., solenoid-controlled, manual, proportional, or any suitable mechanism for altering flow) located along the third flow path 48 controls flow of the engine coolant through the heating coil 46. The engine coolant is heated as it cools the engine, and as the heated coolant flows through the heating coil 46, it defrosts the evaporator coil 24. Such defrosting is preferably done when the blower 26 is not running and the cryogen is not flowing through the evaporator coil 24.

The defrosting may be done by convection if there is a space between the heating and evaporator coils 46, 24 (as shown in FIGS. 2 and 4), or by conduction if the heating coil 46 is an integral part of (or is otherwise metallurgically bonded to) the evaporator coil 24. The illustrated space between the heating coil 46 and the evaporator coil 24 helps prevent freezing of the engine coolant when the cryogen is flowing through the evaporator coil 24.

The second method for defrosting the evaporator coil 24 includes the use of an electric heater 51 (FIG. 4). The electric heater 51 would be potentially useful when the truck 10 is parked and the engine is turned off. Electric current from the engine's alternator (not shown) can be used to drive the electric heater 51. It will be readily apparent to one of ordinary skill in the art that the electricity used to drive the electric heater 51 could alternatively come from a battery, generator, or fuel cell (also not shown). Alternatively, the electric heater 51 may be plugged into an outlet in a nearby building.

The third method of defrosting the evaporator coil 24 includes the use of waste heat. For example, heat from the exhaust of the truck's engine may be routed to a heat exchanger near the evaporator coil. The waste heat contained in the exhaust may then be used to defrost the evaporator coil.

The present invention also contemplates heating the air-conditioned space 12 under appropriate circumstances. For example, this may be desirable on days when the ambient air temperature is below the desired air-conditioned space temperature. To warm the air-conditioned space 12, the blower 26 is activated, along with at least one of the sources of heat described above (heating coil 46, electric heater 51, or waste heat exchanger). At the same time, the flow of cryogen through the evaporator coil 24 is interrupted. The resulting flow of warm air is circulated into the air-conditioned space 12 by the blower 26.

It should be noted that the present application may be adapted for permanently stationary cryogenic temperature control systems. In such systems, waste heat from the building may be used to defrost the evaporator coil or to heat the air-conditioned space. For example, central steam or hot water can be circulated through a heating coil adjacent an evaporator coil to provide the necessary heating. Alternatively, the electric heater may be powered by a building's central electrical system.

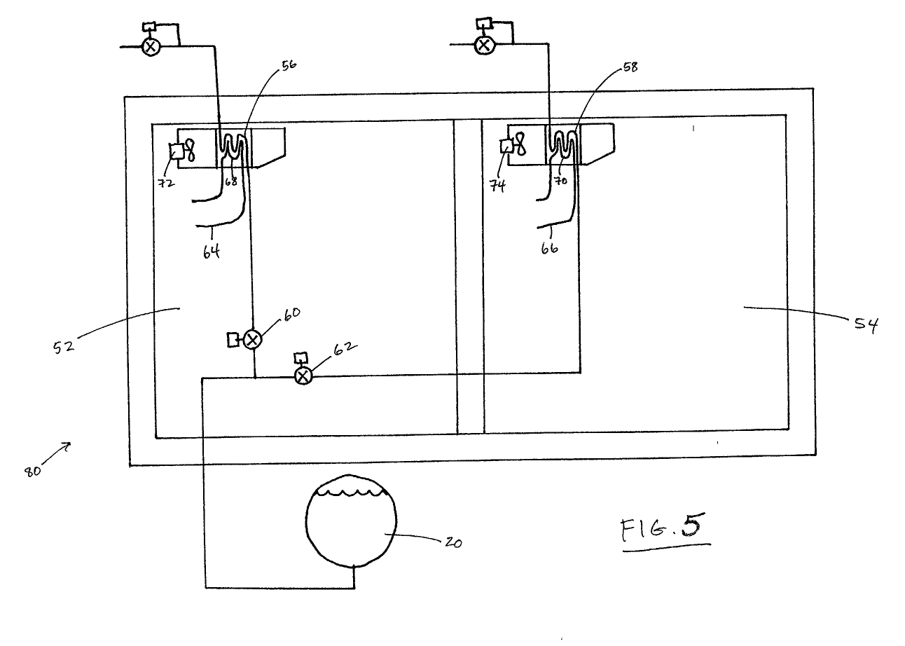

As shown in FIG. 5, the structure and principles discussed above can be applied to a multi-compartment temperature control system 80, wherein the truck trailer 14 is divided into separate first and second compartments 52, 54, in which the temperatures are to be separately controlled. The heat-absorbing fluid storage tank 20 supplies the heat-absorbing fluid to first and second evaporator coils 56, 58. First and second valves 60, 62 regulate the flow of the heat-absorbing fluid through the first and second evaporator coils 56, 58 so that different degrees of cooling may be applied to the first and second compartments 52, 54. Similarly, separate first and second engine coolant flow paths 64, 66, with associated first and second heating coils 68, 70, are established, one for each evaporator coil 56, 58, so that the evaporator coils 56, 58 may be separately defrosted or the compartments 52, 54 separately heated.

FIG. 5 illustrates the multi-compartment temperature control system 80 utilizing open flow paths, wherein a vaporized cryogen is released to the atmosphere after flowing through the evaporator coils 56, 58. As with the single-compartment temperature control system 16, shown in FIGS. 1-4, blowers 72, 74 are driven by electrical energy from the engine. For example, this could be electric current from the alternator or a battery. However, the blowers 72, 74 may also be driven by mechanical energy from the engine through a direct drive, hydraulic linkage, etc.

Although the invention has been described in detail with reference to certain preferred embodiments, variations and modifications exist within the scope and spirit of the invention as described and defined in the following claims.

1. (New) A temperature control system for a motor vehicle having an engine and an air-conditioned space, the temperature control system comprising:
a housing having an air inlet and an air outlet, the air outlet being in fluid communication with the air-conditioned space;
an evaporator coil mounted within the housing, the evaporator coil providing a pathway for a heat-absorbing fluid between a heat-absorbing fluid tank and the atmosphere; and
a blower mounted within the housing between the air inlet and the evaporator coil, the blower being driven by the motor vehicle engine.

2. (New) The temperature control system of claim 1, wherein the heat-absorbing fluid is a cryogen.

3. (New) The temperature control system of claim 1, further including a mechanical linkage between the engine and the blower.

4. (New) The temperature control system of claim 1, wherein the blower is driven by electric current generated by an alternator coupled to the engine.

5. (New) A temperature control system for a motor vehicle including an engine containing an engine coolant within an engine cooling flow path in the engine, and an air-conditioned space, the temperature control system comprising:
a cryogenic temperature control unit including an evaporator coil; and
a heating coil adjacent to the evaporator coil, the heating coil providing a heating flow path for the engine coolant from the engine cooling flow path and back to the engine cooling flow path.

6. (New) The temperature control system of claim 5, wherein the heating coil is integrally formed with the evaporator coil.

7. (New) A temperature control system for a motor vehicle having an engine, an alternator, and an air-conditioned space, the temperature control system comprising:
a housing having an air inlet and an air outlet, the air outlet being in fluid communication with the air-conditioned space;
an evaporator coil mounted within the housing, the evaporator coil providing a first flow path for a heat-absorbing fluid between a heat-absorbing fluid tank and the atmosphere; and
a blower mounted within the housing between the air inlet and the evaporator coil, the blower being electrically driven by current from the alternator.

8. (New) The temperature control system of claim 7, wherein the heat-absorbing fluid is a cryogen.

9. (New) The temperature control system of claim 7, wherein the heat-absorbing fluid is a refrigerant.

10. (New) A cryogenic temperature control system for a motor vehicle having an engine and an air-conditioned space, the cryogenic temperature control system comprising:
an evaporator coil through which a cryogen flows; and
a blower that blows air over the evaporator coil, the blower being driven by the engine.

11. (New) The temperature control system of claim 10, further comprising an alternator coupled to the engine, the alternator producing electric current which drives the blower.

12. (New) A temperature control system for a motor vehicle having an engine and an air conditioned space, the temperature control system comprising:
a housing having an air inlet and an air outlet, the air outlet being in fluid communication with the air-conditioned space;
an evaporator coil mounted within the housing, the evaporator coil providing a pathway for a heat-absorbing fluid;
a blower mounted within the housing between the air inlet and the evaporator coil, the blower being driven by the motor vehicle engine; and
a heating coil adjacent to the evaporator coil, the heating coil providing a heating flow path for engine coolant from the engine and back to the engine.

13. (New) The temperature control system of claim 12, wherein the heat-absorbing fluid is a cryogen.

14. (New) The temperature control system of claim 13, further including an alternator coupled to the engine, the alternator producing electric current which drives the blower.

15. (New) The temperature control system of claim 12, further comprising a compressor in fluid communication with the evaporator and wherein the heat-absorbing fluid is a refrigerant.

16. (New) The temperature control system of claim 15, wherein the heating coil is integrally formed with the evaporator coil.
